(19) United States
(12) Patent Application Publication
(10) Pub. No.: US 2012/0031889 A1
(43) Pub. Date: Feb. 9, 2012

(54) MOUNTING TABLE STRUCTURE AND PROCESSING APPARATUS

(75) Inventor: Tomohito Komatsu, Yamanashi (JP)

(73) Assignee: Tokyo Electron Limited, Tokyo (JP)

(21) Appl. No.: 13/259,822

(22) PCT Filed: Mar. 18, 2010
(86) PCT No.: PCT/JP2010/054668

§ 371 Date: Oct. 12, 2011

(30) Foreign Application Priority Data
Mar. 24, 2009 (JP) 2009-072873

(51) Int. Cl. H05B 3/00

(52) U.S. Cl. 219/201

(57) ABSTRACT

Provided is a mounting table structure on which a target object is mounted to perform a heat treatment on the target object in a processing chamber and which heats the mounted target object. Outermost peripheral feed lines are connected to a plurality of positions different in the circumferential direction of an outermost peripheral resistance heating heater for heating an outermost peripheral heating zone of a mounting table body, thereby dividing the outermost peripheral resistance heating heater into a plurality of heater sections. A heater control unit can individually control electrical states (for example, voltage application states, zero potential states, and floating states) of the respective outermost peripheral feed lines. The power supply state of each of the heater sections can be changed by a simple configuration.

### FIELD OF THE INVENTION

The present invention relates to a processing apparatus for performing a heat treatment, e.g., a plasma treatment or a film formation, on a target object such as a semiconductor wafer and a mounting table structure used in the processing apparatus.

### BACKGROUND OF THE INVENTION

Generally, in order to manufacture a semiconductor device such as an integrated circuit (IC), various treatments such as a film formation, an etching process, a heat treatment and a modification process are repeatedly performed on a target object such as a semiconductor wafer with or without using a plasma. As a consequence, a desired circuit device and the like can be manufactured.

For example, in a single wafer processing apparatus for performing a heat treatment on semiconductor wafers one by one, a mounting table structure having a resistance heater or the like embedded therein is installed in a vacuum evacuable processing chamber. A specific processing gas is supplied to a semiconductor wafer mounted on a top surface of the mounting table structure, and various heat treatments are performed on the wafer under specific process conditions with or without using a plasma (see Japanese Patent Application Publication Nos. S63-278322, H7-78766, H6-260430, 2004-356624, and H10-209255).

In this case, the semiconductor wafer is exposed to a high temperature environment and a corrosive gas such as a cleaning gas and an etching gas is used in the processing chamber. Accordingly, ceramic such as aluminum nitride (AlN) tends to be used for the mounting table structure on which the semiconductor wafer is mounted. In a case where a heater or an electrostatic chuck electrode is provided in the mounting table structure, it is integrally embedded in the ceramic.

An example of a conventional processing apparatus and mounting table structure will be described. FIG. 9 schematically illustrates a conventional general processing apparatus using a plasma. FIG. 10 is a plan view showing a resistance heater of the mounting table structure. FIG. 9 illustrates a plasma processing apparatus as an example of the processing apparatus, wherein a mounting table structure for mounting a semiconductor wafer W on a top surface thereof is provided in a cylindrical processing chamber 2. A shower head 6 serving as a gas introduction unit is provided at a ceiling portion of the processing chamber 2, and a necessary gas is injected through gas injection holes 6A formed on a bottom surface of the shower head 6. A high frequency power supply 8 having a frequency of, e.g., 13.56 MHz for plasma generation is connected to the shower head 6, and the shower head 6 serves as an upper electrode.

Further, a gas exhaust port 10 is provided at a bottom portion of the processing chamber 2 to evacuate the atmosphere inside the processing chamber 2. A gate valve 12 configured to be opened and closed in loading and unloading of the wafer W is provided at one side of a sidewall of the processing chamber 2. An observation window 14 formed of, e.g., quartz glass to observe the inside of the chamber is provided at the other side of the sidewall of the processing chamber 2. The mounting table structure 4 includes a mounting table body 16 for mounting the wafer W thereon, and a support column 18 standing upright on a bottom portion of the chamber to support the mounting table body 16. The mounting table body 16 is formed of ceramic such as AlN having a heat resistance and corrosive resistance. An electrode 20 serving as a lower electrode and a chuck electrode of an electrostatic chuck is embedded in the mounting table body 16. A heating unit 22 having a resistance heater 24 is embedded in the mounting table body 16 below the electrode 20 to heat the wafer W.

As shown in FIG. 10, the resistance heater 24 forming the heating unit 22 includes a resistance heater 24A and a resistance heater 24B which are respectively provided in an inner peripheral zone and an outer peripheral zone concentrically separated from each other. The resistance heaters 24A and 24B of the respective zones are individually controlled to enhance the in-plane uniformity of the temperature of the wafer W.

Attachment ports (not shown) for attaching various measurement devices, e.g., the gate valve 12 and the observation window 14, are appropriately provided in respective portions of the sidewall of the processing chamber 2. Such portions have thermal conditions different from those of other portions of the sidewall. For example, a portion to which the gate valve 12 is attached tends to have a lower temperature because the gate valve 12 is repeatedly opened and closed for loading and unloading of the wafer W. A portion having the observation window 14 may have a temperature different from an ambient temperature because the quartz glass which forms the observation window 14 has a specific heat different from that of metal (e.g., an aluminum alloy) which forms the sidewall of the processing chamber 2. Under these circumstances, a peripheral portion of the wafer W may be adversely affected locally and thermally by an attachment portion of the gate valve 12 and an attachment portion of the observation window which have different temperatures from that of the peripheral portion.

However, the resistance heater 24B of the outer peripheral zone for controlling the temperature of the peripheral portion of the wafer W as described above can control only the entire temperature. Accordingly, when the peripheral portion of the wafer is locally affected by the different thermal conditions, it is difficult to effectively compensate the imbalance in temperature, and it leads to a reduction in the in-plane uniformity of the wafer temperature.

### SUMMARY OF THE INVENTION

The present invention provides a mounting table structure and a processing apparatus capable of controlling a temperature distribution in a peripheral portion of a target object by a simple configuration.

In accordance with an aspect of the present invention, there is provided a mounting table structure for mounting a target object to perform a heat treatment on the target object in a processing chamber, the mounting table structure including: a mounting table body on which the target object is mounted and which is divided into a plurality of concentric heating zones; a plurality of resistance heaters provided in the mounting table body to correspond to the heating zones respectively; a plurality of power feed lines which supply electric powers to the resistance heaters, the power feed lines connected to each of the resistance heaters of the heating zones being different from one another; and a heater control unit provided to independently control the electric powers supplied to the resistance heaters for each of the heating zones.

The resistance heaters include an outermost peripheral resistance heater that is arranged in an outermost peripheral heating zone of the heating zones, and the outermost peripheral resistance heater extends along a circumferential direction of the outermost peripheral heating zone. Further, the power feed lines include a plurality of outermost peripheral power feed lines to supply electric powers to the outermost peripheral resistance heater. The outermost peripheral power feed lines are respectively connected to a plurality of different positions of the outermost peripheral resistance heater in the circumferential direction, so that the outermost peripheral resistance heater is divided into a plurality of heater sections by the positions, and the heater control unit is configured to individually control electrical states of the respective outermost peripheral power feed lines.

The outermost peripheral resistance heater may be a heater with no ends continuously extending along an entire circumference of the outermost peripheral heating zone.

Further, the heater control unit may have a plurality of different power supply states for the outermost peripheral resistance heater, each of the power supply states is a combination of the electrical states of the respective outermost peripheral power feed lines, and the heater control unit may be configured to switch the power supply states by time division control.

Further, the outermost peripheral resistance heater may be divided into an even number of the heater sections. The heater control unit may have a power supply state to allow currents to flow in all of the heater sections of the outermost peripheral resistance heater. The heater control unit may have a power supply state to allow currents to flow in selected two of the heater sections opposite to each other. The heater control unit may have a power supply state to allow currents to flow in selected two of the heater sections adjacent to each other.

Further, the outermost peripheral resistance heater may be divided into an odd number of the heater sections. The heater control unit may have a power supply state to allow currents to flow in selected two of the heater sections adjacent to each other.

Further, the heater control unit may have a power supply state to set one or more of the outermost peripheral power feed lines in a floating state.

Further, the outermost peripheral resistance heater may be divided into three or more heater sections.

Further, the mounting table body may be formed of a ceramic material or quartz.

In accordance with another aspect of the present invention, there is provided a processing apparatus for performing a heat treatment on a target object, the apparatus including: an evacuable processing chamber; the above-described mounting table structure provided in the processing chamber to mount the target object; and a gas introduction unit which introduces a gas into the processing chamber.

### BRIEF DESCRIPTION OF THE DRAWINGS

FIG. 1 illustrates a processing apparatus having a mounting table structure in accordance with an embodiment of the present invention.

FIG. 2 is a cross-sectional view schematically showing an inside of a processing chamber.

FIGS. 3A and 3B are plan views showing an arrangement of resistance heaters serving as a heating unit.

FIG. 4 illustrates a relationship between power supply states and electrical states of outermost peripheral power feed lines when an outermost peripheral zone is divided into four sections.

FIGS. 5A and 5B illustrate examples of variation in power supply states when a specific heater section is controlled to be maintained at a high temperature or low temperature.

FIG. 6 illustrates examples of the power supply states when at least one of the outermost peripheral power feed lines is set in a floating state.

FIG. 7 schematically illustrates a case where the resistance heater of the outermost peripheral zone is divided into three parts.

FIG. 8 illustrates a relationship between power supply states and electrical states of the outermost peripheral power feed lines when the outermost peripheral zone is divided into three sections.

FIG. 9 illustrates a conventional general processing apparatus using a plasma.

FIG. 10 is a plan view showing a resistance heater of a mounting table structure.

### DETAILED DESCRIPTION OF THE EMBODIMENTS

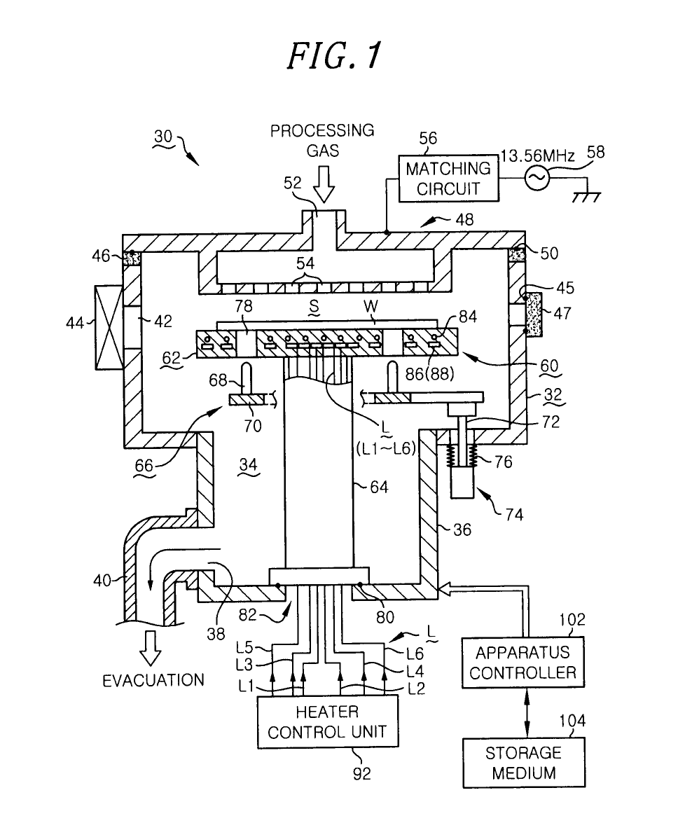

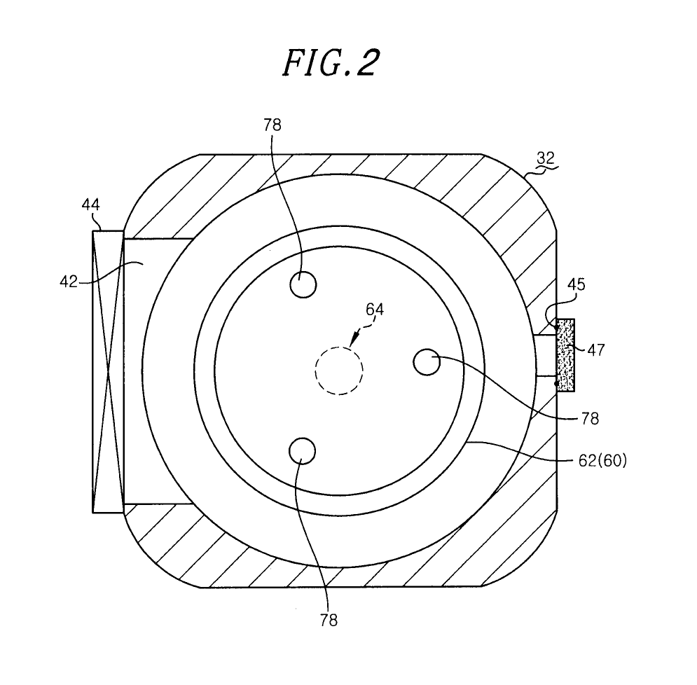

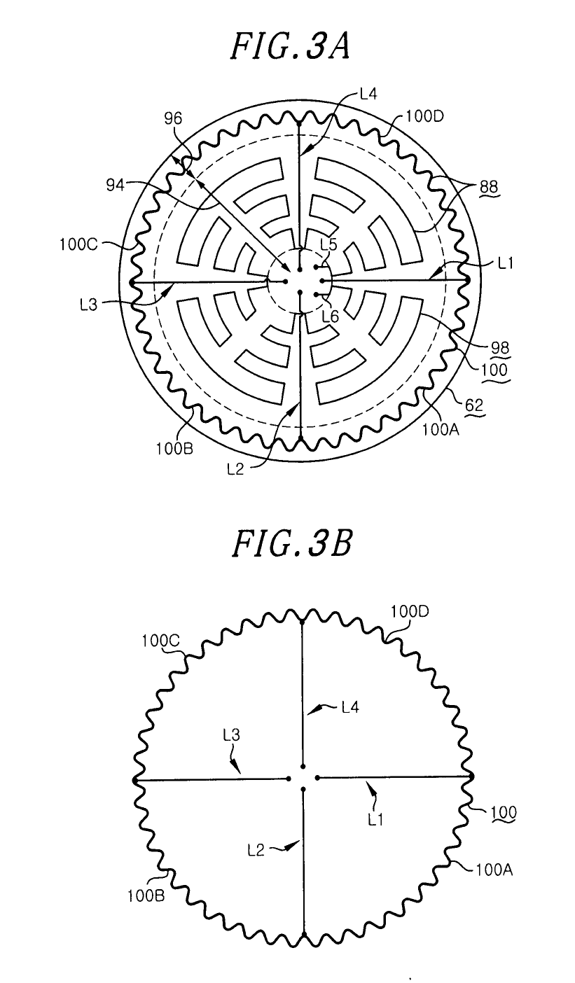

Hereinafter, a mounting table structure and a processing apparatus in accordance with an embodiment of the present invention will be described in detail with reference to the accompanying drawings. FIG. 1 illustrates a processing apparatus having a mounting table structure in accordance with the embodiment of the present invention. FIG. 2 is a cross-sectional view schematically showing an inside of a processing chamber. FIGS. 3A and 3B are plan views showing an arrangement of resistance heaters serving as a heating unit.

In this embodiment, a parallel plate plasma processing apparatus will be described as an example of the processing apparatus in accordance with the embodiment of the present invention. As illustrated in FIG. 1, a parallel plate plasma processing apparatus 30 includes a processing chamber 32 formed of, e.g., an aluminum alloy in a cylindrical shape. A gas exhaust space 34 is formed at the center of a bottom portion of the processing chamber 32 and defined by a downwardly extending defining wall 36 of a cylindrical shape having a bottom surface. The bottom surface of the defining wall 36 becomes a part of the bottom portion of the processing chamber 32. A gas exhaust port 38 is provided at a sidewall of the defining wall 36. The gas exhaust port 38 is connected to a gas exhaust pipe 40 in which a pressure control valve or a vacuum pump (not shown) are provided, so that the processing chamber 32 can be vacuum evacuated to a desired pressure.

A loading/unloading opening 42 through which a target object, e.g., a semiconductor wafer W is loaded and unloaded is formed at a sidewall of the processing chamber 32 as also shown in FIG. 2. A gate valve 44 is provided at the loading/unloading opening 42. The gate valve 44 is opened and closed in loading and unloading of the wafer W. An observation window 47 is provided at a portion of the sidewall of the processing chamber 32, opposite to a portion of the sidewall at which the gate valve 44 is provided. The observation window 47 formed of, e.g., quartz glass is airtightly provided via a seal member 45 such as an O ring, so that an inside of the processing chamber 32 can be observed if necessary. Various components such as ports (not shown) for attachment of various measuring instruments, which lead to thermal imbalance, are formed at the sidewall of the processing chamber 32.

A ceiling of the processing chamber 32 is opened, and a shower head 48 serving as a gas introduction unit is installed at the opened ceiling via an insulating member 46. A seal member 50 such as an O ring is interposed between the shower head 48 and the insulating member 46 to maintain airtightness inside the processing chamber 32. A gas inlet port 52 is provided at an upper portion of the shower head 48, and a plurality of gas injection holes 54 is provided at a gas injection surface of a lower portion of the shower head 48 to inject a desired processing gas toward a processing space S. Although one room is formed in the shower head 48 in the illustrated example, a shower head having a plurality of rooms therein to separately supply different gases into the processing space S without mixing the gases in the shower head 48 may be provided.

The shower head 48 serves as an upper electrode for plasma generation. Specifically, the shower head 48 is connected to a high frequency power supply 58 for plasma generation via a matching circuit 56. The frequency of the high frequency power supply 58 is, e.g., 13.56 MHz, but it is not limited thereto. A mounting table structure 60 in accordance with the embodiment of the present invention is provided in the processing chamber 32 to mount the semiconductor wafer W thereon. The mounting table structure 60 has a circular plate-shaped mounting table body 62 for directly mounting the wafer W on its top surface, i.e., a mounting surface. The mounting table body 62 is supported by a support column 64 standing upright on the bottom portion of the processing chamber 32.

A pin elevating mechanism 66 is provided below the mounting table body 62 to lift up and support the wafer W in loading and unloading of the wafer W. The pin elevating mechanism 66 has, e.g., three elevating pins 68 (only two pins are illustrated in the example) which are equi-spaced in a circumferential direction of the mounting table body 62. Lower end portions of the elevating pins 68 are supported by a pin base plate 70 of, e.g., a circular arc shape. The pin base plate 70 is connected to an elevation rod 72 passing through the bottom portion of the processing chamber 32. The elevation rod 72 is attached to an actuator 74 which moves the elevation rod 72 up and down. A bellows 76 that is expansible and contractible to allow a vertical movement of the elevation rod 72 while maintaining airtightness inside the processing chamber 32 is provided at a part of the bottom portion of the processing chamber 32 through which the elevation rod 72 passes.

Pin insertion through holes 78 are provided in the mounting table body 62 to correspond to the elevating pins 68. The elevating pins 68 inserted through the pin insertion through holes 78 move up from the mounting surface of the mounting table body 62 by vertically moving the elevation rod 72, thereby elevating the wafer W.

The mounting table body 62 and the support column 64 are entirely formed of a material, e.g., a ceramic material or quartz, having an excellent heat resistance without causing metal contamination. The support column 64 has a cylindrical shape and the upper end of the support column 64 is bonded to a central portion of a lower surface (rear surface) of the mounting table body 62 by, e.g., thermal diffusion bonding. A lower end portion of the support column 64 is connected to a peripheral portion of an opening 82 formed at the bottom portion of the processing chamber 32 by bolts or the like (not shown) via a seal member 80 such as an ring to maintain airtightness inside the processing chamber 32. One of aluminum nitride (AlN), aluminum oxide (Al₂O₃), silicon carbide (SiC) and the like may be used as the ceramic material.

A chuck electrode 84 of an electrostatic chuck and resistance heaters 88 serving as a heating unit are embedded in the mounting table body 62. The chuck electrode 84 is provided right below the mounting surface to generate an electrostatic force for attracting and holding the wafer W. The resistance heaters 88 for heating wafer W are provided below the chuck electrode 84.

In this embodiment, the chuck electrode 84 also serves as a lower electrode for plasma generation. The chuck electrode 84 is connected to a DC power supply (not shown) for generating a high voltage for attracting and holding the wafer W through a power feed line for a chuck and a high frequency power supply (not shown) for applying a bias voltage for attracting ions of a plasma.

The resistance heaters 88 are connected to power feed lines L (L1 to L6). The power feed lines L are extracted out of the processing chamber 32 through the cylindrical support column 64. Each of the power feed lines L is connected to a heater control unit 92 having a heater power supply, a computer and the like to control the electric power supplied to the resistance heaters 88, thereby controlling the temperature of the wafer W. A thermocouple (not shown) for the temperature control is provided at a lower portion of the mounting table body 62, and the output of the thermocouple is inputted to the heater control unit 92. A nonreactive gas such as N₂ and Ar is supplied into the support column 64 to thereby prevent corrosion of the power feed lines L and the like.

As shown in FIGS. 3A and 3B, the mounting table body 62 is divided into a plurality of concentric heating zones (hereinafter, referred to as “zones”). In the illustrated example, the mounting table body 62 is divided into two concentric (circular) zones, i.e., a circular inner peripheral zone 94 provided at a central portion of the mounting table body 62 and a ring-shaped outer peripheral zone 96 surrounding the inner peripheral zone 94. In the illustrated example, since the outer peripheral zone 96 is located at the outermost periphery, the outer peripheral zone 96 is an outermost peripheral zone.

The resistance heaters 88 include a resistance heater 98 provided in the inner peripheral zone 94 and a resistance heater 100 provided in the outer peripheral zone 96. The resistance heaters 98 and 100 provided in different zones are connected to the different power feed lines L, respectively. In this case, FIG. 3A illustrates an arrangement of all of the resistance heaters 98 and 100, and FIG. 3B illustrates only an arrangement of the resistance heater 100 provided in the outer peripheral zone 96.

Both ends of the resistance heater 98 of the inner peripheral zone 94 are connected to power feed lines L5 and L6, respectively. The resistance heater 98 continuously extends in a zigzag shape throughout the whole region of the inner peripheral zone 94 without disconnection from one end connected to the power feed line L5 to the other end connected to the power feed line L6.

The resistance heater 100 arranged in the outer peripheral zone 96 serving as an outermost peripheral zone, i.e., an outermost peripheral resistance heater, continuously extends throughout the entire circumference along a circumferential direction of the outer peripheral zone 96 (meanderingly in the outer peripheral zone 96 in the illustrated example), and entire shape thereof is a ring (annular) shape with no ends. Further, an arrangement pattern of each of the resistance heaters 98 and 100 is not particularly limited to the above example. The resistance heater 100 serving as the outermost peripheral resistance heater (hereinafter, also referred to as an “outermost peripheral resistance heater”) is connected, at a plurality of circumferential positions, to power feed lines L1 to L4 different from the power feed lines L5 and L6 for the inner peripheral zone 94. That is, the outermost peripheral resistance heater 100 is divided into a plurality of heater sections at the connection points with the power feed lines L1 to L4.

In the illustrated example, the outermost peripheral resistance heater 100 is connected to the four (even number) power feed lines L1, L2, L3 and L4 at the equi-spaced positions thereof, respectively, to divide the outermost peripheral resistance heater 100 into four heater sections 100A, 100B, 100C and 100D. Since the power feed lines L1 to L4 are connected to the outermost peripheral resistance heater 100, they are also referred to as outermost peripheral power feed lines.

The outermost peripheral power feed lines L1 to L4 extend to a central portion of the mounting table body 62, and are inserted into and pass through the cylindrical support column 64 to be connected to the heater control unit 92. Various combinations of the electric powers supplied to the heater sections 100A to 100D (currents flowing in the heater sections 100A to 100D) can be achieved by controlling the electrical states of the outermost peripheral power feed lines L1 to L4.

The thermocouple (not shown) is provided at the rear surface (lower surface) of the mounting table body 62 as described above. The temperature measurement results obtained by the thermocouple are inputted to the heater control unit 92, and the entire temperature of the mounting table body 62 is controlled based on the measurement results. Further, the thermocouple may be provided in each zone. Moreover, the thermocouple may be provided in each zone and also provided in each of the heater sections 100A to 100D in the outermost peripheral zone.

The entire operation of the plasma processing apparatus 30 is controlled by an apparatus controller 102 having, e.g., a computer and the like. Programs of the computer for performing a control operation are stored in a storage medium 104 such as a flexible disc, compact disc (CD), a hard disc, a flash memory or DVD. Specifically, start and stop of gas supply, a gas flow rate, a supply and power of microwaves or high frequency power, a process temperature and a process pressure and the like are controlled by the instructions transmitted from the apparatus controller 102. Further, the heater control unit may be operated under the control of the apparatus controller 102.

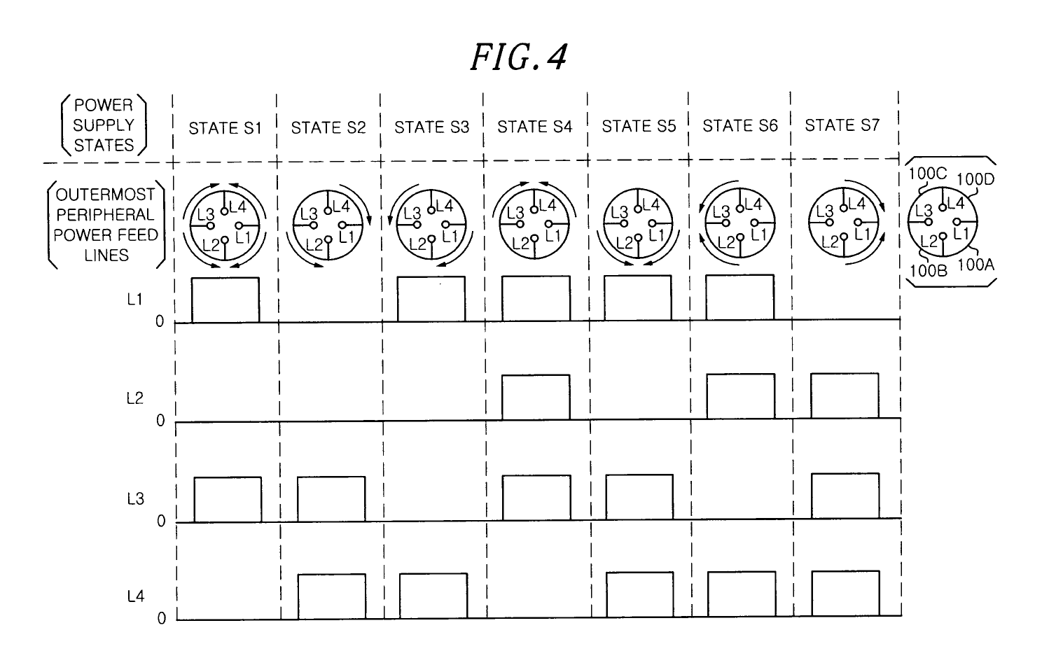

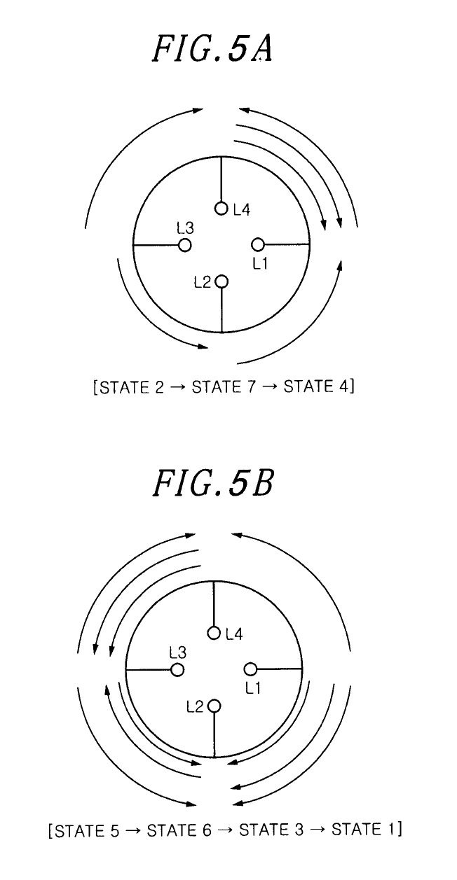

Next, the operation of the plasma processing apparatus having the above configuration will be described with reference to FIGS. 4 to 5B. FIG. 4 illustrates a relationship between power supply states and the electrical states of the outermost peripheral power feed lines when the outermost peripheral zone is divided into four sections. FIGS. 5A and 5B illustrate examples of variation in power supply states when a specific heater section is controlled to be maintained at a high or a low temperature.

First, the unprocessed wafer W is loaded into the processing chamber 32 through the gate valve 44 and the loading/unloading opening 42 while being supported by a transfer arm (not shown). After the wafer W is delivered onto the lifted elevating pins 68, the wafer W is mounted on the upper surface of the mounting table body 62 of the mounting table structure 60 by moving down the elevating pins 68.

Then, various processing gases, e.g., film forming gases, are supplied to the shower head 48 while controlling their flow rates, and injected through the gas injection holes 54 to the processing space S. Further, the processing chamber 32 or the gas exhaust space 34 is vacuum evacuated by continuously operating the vacuum pump (not shown) provided to be connected to the gas exhaust pipe 40. Further, an inner pressure of the processing space S is maintained at a predetermined process pressure by controlling the opening degree of the pressure control valve (not shown). In this case, the temperature of the wafer W is maintained at a specific process temperature. That is, the resistance heaters 88 serving as the heating unit 86 of the mounting table body 62 are heated by applying voltages to the resistance heaters 88 from the heater control unit 92 having the heater power supply through the power feed lines L1 to L6, thereby heating the entire mounting table body 62.

Consequently, the wafer W mounted on the mounting table body 62 is heated to an increased temperature. In this case, the temperature of the wafer W is measured by the thermocouple (not shown) provided in the mounting table body 62, and the temperature control is performed by the heater control unit 92 based on the measurement results. The temperature control states in this case will be described later.

Further, in order to perform a plasma process, a high frequency voltage is applied between the shower head 48 serving as the upper electrode and the mounting table body 62 serving as the lower electrode by driving the high frequency power supply 58, such that a plasma is generated in the processing space S. At the same time, a high DC voltage is applied to the chuck electrode 84 of the electrostatic chuck to attract and hold the wafer W by an electrostatic force. In this state, a desired plasma process is performed. Further, ions of the plasma can be attracted to the wafer W by applying a high frequency power to the chuck electrode 84 of the mounting table body 62 from a high frequency bias power supply (not shown). Accordingly, the plasma process, e.g., a film formation, is performed on the surface of the wafer W.

Further, as described above, while the plasma process such as a film formation or the like is performed on the wafer W, the electric powers are individually controlled and supplied from the heater control unit 92 to the respective resistance heaters 98 and 100 corresponding to the respective zones 94 and 96 by feedback control. In this embodiment, a switching device such as a thyristor is included in the heater control unit 92, and the electric powers may be supplied in pulse shapes to the resistance heaters 98 and 100 by time division by driving the switching device.

The electric power is supplied to the resistance heater 98 of the inner peripheral zone 94 by feedback control through the power feed lines L5 to L6, and the temperature of the inner peripheral zone 94 is controlled as a whole.

On the other hand, the outermost peripheral resistance heater 100 of the outermost peripheral zone (outer peripheral zone) 96 is divided into the four heater sections 100A to 100D in the circumferential direction. The power supply state of each of the heater sections 100A to 100D can be changed by individually controlling each of the electrical states (e.g., potentials) of the four outermost peripheral power feed lines L1 to L4.

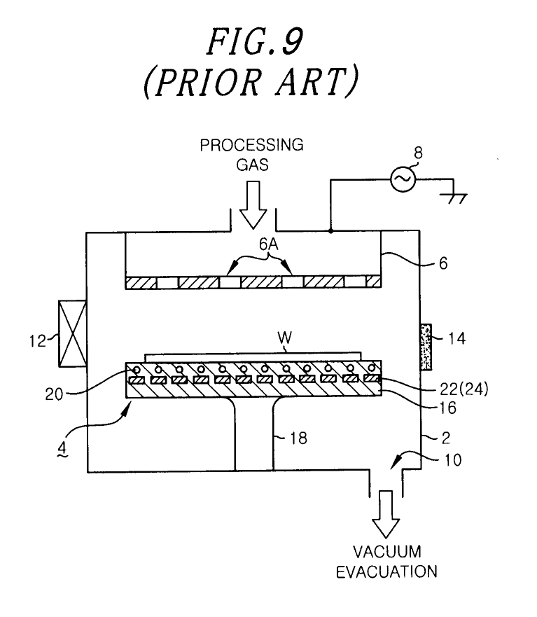

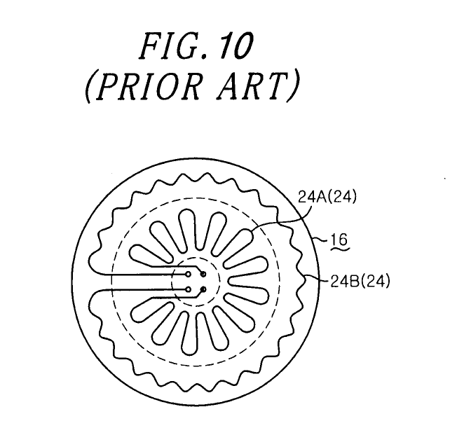

As described above with reference to FIGS. 9 and 10, in the conventional mounting table structure, a component such as the gate valve 12 and the observation window 14 provided at the sidewall or the like of the processing chamber 2 causes thermal imbalance, so that the temperature of a peripheral region of the wafer close to the component locally increases or decreases compared to other regions, thereby reducing the in-plane uniformity of the temperature of the wafer.

However, in the mounting table structure in accordance with the embodiment of the present invention, as described above, the outermost peripheral resistance heater 100 of the outermost peripheral zone 96 is divided into a plurality of, e.g., four, heater sections 100A to 100D, and the power supply control, i.e., temperature control of each of the heater sections 100A to 100D can be individually performed. Accordingly, even though there is a component such as the gate valve 44 and the observation window 47 causing thermal imbalance as described above, it is possible to correct the thermal imbalance to thereby suppress such imbalance and improve the in-plane uniformity of the temperature of the wafer W.

The power supply state of each of the heater sections of the outermost peripheral resistance heater 100 will be described in detail with reference to FIGS. 4 to 5B. FIG. 4 illustrates potentials (applied voltages) of the outermost peripheral power feed lines L1 to L4 in each state. The presence of a pulse indicates that a voltage (e.g., 200 V) is applied to the power feed line, and the absence of a pulse indicates that a voltage applied to the power feed line is zero, that is, the power feed line is grounded.

Further, in this case, states S1 to S7 are shown as examples of the power supply states, and a current flow direction of each state is indicated by an arrow in each of the heater sections. The states S1 to S7 are appropriately selected such that the temperature of the outermost peripheral zone 96 is controlled by switching the selected states in a time division manner.

In state S1, a voltage is applied to the outermost peripheral power feed lines L1 and L3 and a zero voltage is applied to the outermost peripheral power feed lines L2 and L4, thereby allowing currents to flow in all of the heater sections 100A to 100D. In this case, the temperature of the outermost peripheral zone 96 is uniformly increased. Further, by applying a voltage to the outermost peripheral power feed lines L2 and L4 instead of the outermost peripheral power feed lines L1 and L3, it is also possible to allow currents to flow in all of the heater sections 100A to 100D, though in an opposite direction.

In state S2, a voltage is applied to the outermost peripheral power feed lines L3 and L4 and a zero voltage is applied to the outermost peripheral power feed lines L1 and L2. Accordingly, currents flow in the heater sections 100B and 100D and do not flow in the heater sections 100A and 100C. That is, in this case, the currents may flow in a pair of the selected heater sections 100B and 100D opposite to each other. Further, by applying a voltage to the outermost peripheral power feed lines L1 and L2 instead of the outermost peripheral power feed lines L3 and L4, it is also possible to allow currents to flow in the heater sections 100B and 100D, though in an opposite direction. In state S2, it is possible to heat only the heater sections 100B and 100D.

In state S3, a voltage is applied to the outermost peripheral power feed lines L1 and L4 and a zero voltage is applied to the outermost peripheral power feed lines L2 and L3. Accordingly, currents flow in the heater sections 100A and 100C and do not flow in the heater sections 100B and 100D. That is, in this case, the currents may flow in a pair of the selected heater sections 100A and 100C opposite to each other. Further, by applying a voltage to the outermost peripheral power feed lines L2 and L3 instead of the outermost peripheral power feed lines L1 and L4, it is also possible to allow currents to flow in the heater sections 100A and 100C, though in an opposite direction. In state S3, it is possible to heat only the heater sections 100A and 100C.

In state S4, a voltage is applied to the outermost peripheral power feed lines L1, L2 and L3 and a zero voltage is applied to the outermost peripheral power feed line L4. Accordingly, currents flow in the heater sections 100C and 100D and do not flow in the heater sections 100A and 100B. That is, in this case, the currents may flow in a pair of the selected heater sections 100C and 100D adjacent to each other. In state S4, it is possible to heat only the heater sections 100C and 100D.

In state S5, a voltage is applied to the outermost peripheral power feed lines L1, L3 and L4 and a zero voltage is applied to the outermost peripheral power feed line L2. Accordingly, currents flow in the heater sections 100A and 100B and do not flow in the heater sections 100C and 100D. That is, in this case, the currents may flow in a pair of the selected heater sections 100A and 100B adjacent to each other. In state S5, it is possible to heat only the heater sections 100A and 100B.

In state S6, a voltage is applied to the outermost peripheral power feed lines L1, L2 and L4 and a zero voltage is applied to the outermost peripheral power feed line L3. Accordingly, currents flow in the heater sections 100B and 100C and do not flow in the heater sections 100A and 100D. That is, in this case, the currents may flow in a pair of the selected heater sections 100B and 100C adjacent to each other. In state S6, it is possible to heat only the heater sections 100B and 100C.

In state S7, a voltage is applied to the outermost peripheral power feed lines L2, L3 and L4 and a zero voltage is applied to the outermost peripheral power feed line L1. Accordingly, currents flow in the heater sections 100A and 100D and do not flow in the heater sections 100B and 100C. That is, in this case, the currents may flow in a pair of the selected heater sections 100A and 100D adjacent to each other. In state S7, it is possible to heat only the heater sections 100A and 100D.

Further, the power supply states, e.g., three states of state S2→state S7→state S4 (regardless of the order) as shown in FIG. 5A, may be combined and controlled by time division, thereby heating only the heater section 100D to a higher temperature compared to those of the heater sections 100A to 100C. Further, arrows of FIG. 5A indicate directions of current as in FIG. 4. Therefore, in the same manner as the above, it is possible to heat only one of the heater sections 100A to 100C to a higher temperature compared to those of the other heater sections by appropriately combining the power supply states.

Further, the power supply states, e.g., four states of state S5→state S6→state S3→state S1 (regardless of the order) as shown in FIG. 5B, may be combined and controlled by time division, thereby heating only the heater section 100D to a lower temperature compared to those of the heater sections 100A to 100C. Further, arrows of FIG. 5B indicate directions of current as in FIG. 4. Therefore, in the same manner as the above, it is also possible to heat only one of the heater sections 100A to 100C to a lower temperature compared to those of the other heater sections by appropriately combining the power supply states.

Further, it is possible to control the electric power supplied to each of the heater sections 100A to 100D by varying a pulse width of the pulse-shaped power applied to each of the outermost peripheral power feed lines L1 to L4, i.e., varying a duty ratio. Actually, it is preferable to perform the temperature control of the outermost peripheral zone 96 by varying the power supply states and controlling a duty ratio to vary the pulse width of the applied power.

For example, in a case where the temperatures of the peripheral portions of the wafer W, e.g., the heater sections 100A and 100C, corresponding to the gate valve 44 and the observation window 47 opposite to each other in the sidewall of the processing chamber 32 tend to decrease, temperature compensation is performed on the corresponding portions by increasing the current flowing time, e.g., as shown in state S3, to make the electric powers supplied to the heater sections 100A and 100C larger than the electric powers supplied to the other heater sections 100B and 100D.

Accordingly, since the amount of heat supplied to the peripheral portion of the wafer W corresponding to the gate valve 44 or the observation window 47 increases, it is possible to make a uniform temperature distribution in the circumferential direction of the peripheral portion of the wafer W corresponding to the outer peripheral zone. Consequently, it is possible to increase the in-plane uniformity of the temperature of the wafer W including the inner peripheral zone. Further, the above-described states S1 to S7 are merely exemplary and the combination of the voltage application states and the zero voltage application states in the outermost peripheral power feed lines L1 to L4 can be arbitrarily set.

By performing the control of the electric power supplied to the outermost peripheral resistance heater 100 as described above, it is possible to uniformly maintain the temperature distribution in the circumferential direction of the peripheral portion of the wafer W even though the peripheral portion of the wafer W is affected by the non-uniform heat supplied from the sidewall of the processing chamber 2. Consequently, it is possible to improve the in-plane uniformity of the temperature of the wafer W.

Further, it is possible to simplify the arrangement of the outermost peripheral resistance heater 100 and the outermost peripheral power feed lines L1 to L4. The outermost peripheral resistance heater may be formed of a plurality of (e.g., four) resistance heaters and the electric powers supplied to the plurality of resistance heaters may be individually controlled. In this case, however, it is required to provide a considerably large number of outermost peripheral power feed lines in the mounting table body 62. For example, in a case where the outermost peripheral resistance heater is divided into four heater sections in the present embodiment, four outermost peripheral power feed lines are required. On the other hand, in case of using four resistance heaters separated from each other, eight outermost peripheral power feed lines are required. Further, it is troublesome to arrange a plurality of resistance heaters separated from each other.

Therefore, in accordance with the embodiment of the present invention, it is possible to simply install the outermost peripheral resistance heater and the outermost peripheral power feed lines, and reduce the time and cost required for the manufacture of the mounting table body. Meanwhile, there is no particular difference in controlling the heater control unit 92 between a case of using the four resistance heaters separated from each other and a case where the outermost peripheral resistance heater is divided into four heater sections as in the present embodiment.

(Case where Electrical States of Power Feed Lines Include Floating State)

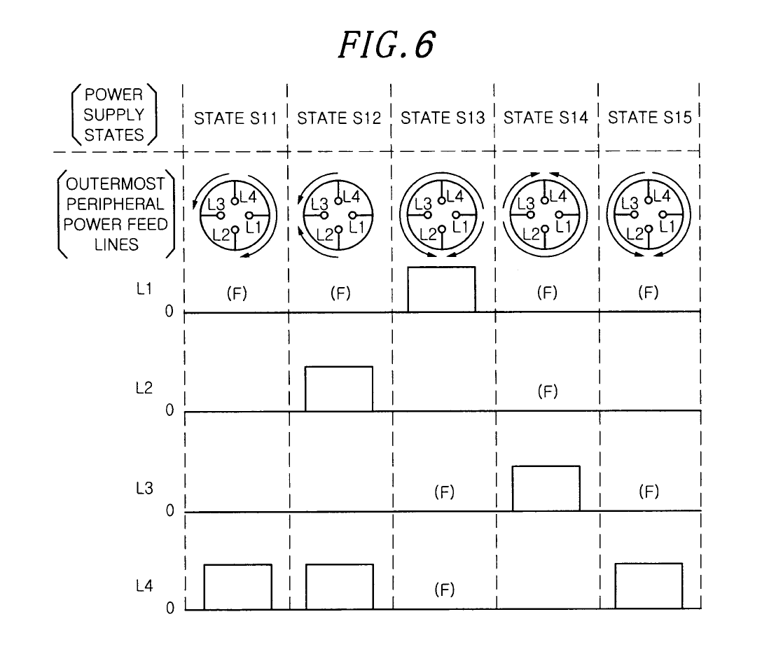

The electrical state of each of the outermost peripheral power feed lines described in FIGS. 4 to 5B is one of a state in which a specific voltage is applied and a state in which a zero voltage is applied (ground). In addition to the two states, the electrical states may include a floating state (in which no voltage is applied to the outermost peripheral power feed line, and at the same time the outermost peripheral power feed line is not grounded to thereby making the power feed line electrically float). FIG. 6 illustrates examples of the power supply states when at least one of the outermost peripheral power feed lines is set in a floating state. In FIG. 6, “F” indicates a floating state and the others indicate the same as those shown in FIG. 4.

In state S11, one of the outermost peripheral power feed lines, e.g., the outermost peripheral power feed line L1 is set in a floating state, a voltage is applied to another one of the outermost peripheral power feed lines, e.g., the outermost peripheral power feed line L4, and a zero voltage is applied to the remaining outermost peripheral power feed lines, e.g., the outermost peripheral power feed lines L2 and L3.

In this case, currents flow in the heater sections 100A, 100C and 100D and no current flows in the heater section 100B. Further, the heater sections 100A and 100D are connected in series to each other. The current flowing in the heater sections 100A and 100D is a half (½) of the current flowing in the heater section 100C (the electric power applied to each of the heater sections 100A and 100D is ¼ of the electric power applied to the heater section 100C.

In state S12, one of the outermost peripheral power feed lines, e.g., the outermost peripheral power feed line L1 is set in a floating state, a voltage is applied to two other ones of the outermost peripheral power feed lines, e.g., the outermost peripheral power feed lines L2 and L4, and a zero voltage is applied to the remaining outermost peripheral power feed line, e.g., the outermost peripheral power feed line L3. In this case, currents flow in the heater sections 100B and 100C and do not flow in the heater sections 100A and 100D.

In state S13, two of the outermost peripheral power feed lines, e.g., the outermost peripheral power feed lines L3 and L4 are set in a floating state, a voltage is applied to another one of the outermost peripheral power feed lines, e.g., the outermost peripheral power feed line L1, and a zero voltage is applied to the remaining outermost peripheral power feed line, e.g., the outermost peripheral power feed line L2. In this case, currents flow in all of the heater sections 100A to 100D. In this case, the heater sections 100B, 100C and 100D are connected in series between the outermost peripheral power feed lines L1 and L2 involved in the current supply. The current flowing in the heater sections 100B, 100C and 100D is ⅓ of the current flowing in the heater section 100A (the electric power applied to each of the heater sections 100B, 100C and 100D is 1/9 of the electric power applied to the heater section 100A).

In state S14, two of the outermost peripheral power feed lines, e.g., the outermost peripheral power feed lines L1 and L2 are set in a floating state, a voltage is applied to another one of the outermost peripheral power feed lines, e.g., the outermost peripheral power feed line L3, and a zero voltage is applied to the remaining outermost peripheral power feed line, e.g., the outermost peripheral power feed line L4. In this case, currents flow in all of the heater sections 100A to 100D as in state S13. Further, the heater sections 100D, 100A and 100B are connected in series between the outermost peripheral power feed lines L3 and L4 involved in the current supply. The current flowing in the heater sections 100D, 100A and 100B is ⅓ of the current flowing in the heater section 100C (the electric power applied to each of the heater sections 100D, 100A and 100B is 1/9 of the electric power applied to the heater section 100C).

In state S15, two of the outermost peripheral power feed lines, e.g., the outermost peripheral power feed lines L1 and L3 are set in a floating state, a voltage is applied to another one of the outermost peripheral power feed lines, e.g., the outermost peripheral power feed line L4, and a zero voltage is applied to the remaining outermost peripheral power feed line, e.g., the outermost peripheral power feed line L2.

In this case, currents flow in all of the heater sections 100A to 100D. Further, the heater sections 100A and 100D are connected in series and the heater sections 100B and 100C are connected in series between the outermost peripheral power feed lines L4 and L2 involved in the current supply.

As described above, the power supply states of the states S11 to S15 and the power supply states shown in FIG. 4 may be combined and controlled by time division, so that the temperature control is more specifically performed. Further, the states S11 to S15 are merely examples of the outermost peripheral power feed lines, at least one of which is set in a floating state, and it is not limited thereto.

In other words, in this case, five states of the states S11 to S15 are representatively illustrated. Since the heater sections 100A to 100D and the outermost peripheral power feed lines L1 to L4 have rotational symmetry, it is obvious to obtain the same power supply pattern when the power supply pattern shown in the states S11 to S15 is rotated by 90 degrees.

(Embodiment in which Outermost Peripheral Zone is Divided into Three Sections)

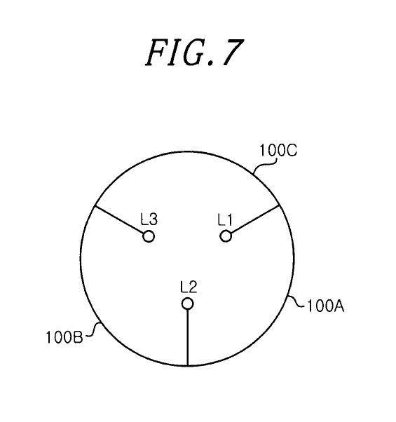

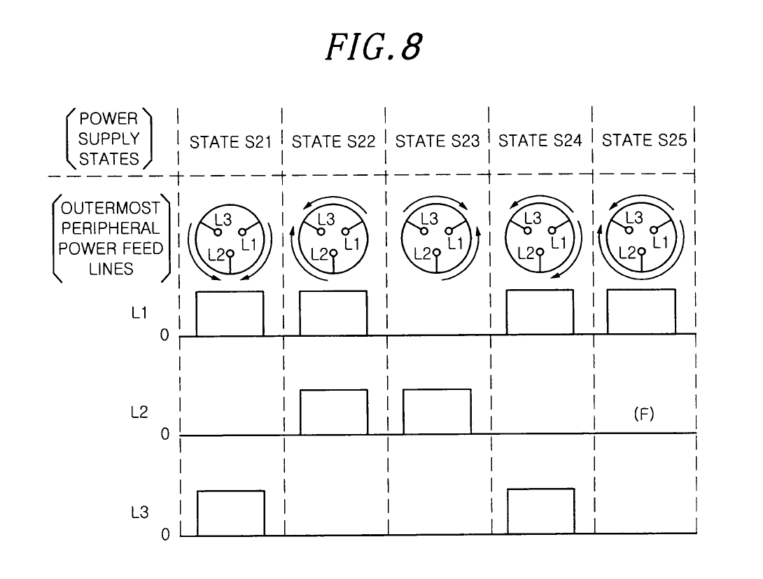

Although the case where the resistance heater of the outermost peripheral zone is divided into even number (four) of sections has been described in the above embodiment, the resistance heater of the outermost peripheral zone may be divided into odd number (e.g., three) of sections. FIGS. 7 and 8 illustrate such a case, wherein FIG. 7 schematically illustrates the case where the resistance heater of the outermost peripheral zone is divided into three sections, and FIG. 8 illustrates a relationship between the power supply states and the states of the outermost peripheral power feed lines when the outermost peripheral zone is divided into three sections. Further, FIG. 8 illustrates a diagram in the same way as those shown in FIGS. 4 and 6.

As illustrated in FIG. 7, in this embodiment, three outermost peripheral power feed lines L1, L2 and L3 are connected to the outermost peripheral resistance heater 100 such that the outermost peripheral resistance heater 100 is divided into three heater sections 100A, 100B and 100C in its circumferential direction.

For example, the power supply states shown in FIG. 8 can be realized in this embodiment. In state S21, a voltage is applied to two of the outermost peripheral power feed lines L1 to L3, e.g., the outermost peripheral power feed lines L1 and L3, and a zero voltage is applied to the outermost peripheral power feed line L2. In this case, currents may flow in the two selected heater sections 100A and 100B adjacent to each other. In the state S21, it is possible to heat only the heater sections 100A and 100B.

In state S22, a voltage is applied to two of the outermost peripheral power feed lines L1 to L3, e.g., the outermost peripheral power feed lines L1 and L2, and a zero voltage is applied to the outermost peripheral power feed line L3. In this case, currents may flow in the two selected heater sections 100B and 100C adjacent to each other. In the state S22, it is possible to heat only the heater sections 100B and 100C.

In state S23, a voltage is applied to two of the outermost peripheral power feed lines L1 to L3, e.g., the outermost peripheral power feed lines L2 and L3, and a zero voltage is applied to the outermost peripheral power feed line L1. In this case, currents may flow in the two selected heater sections 100A and 100C adjacent to each other. In the state S23, it is possible to heat only the heater sections 100A and 100C.

In state S24, a voltage is applied to one of the outermost peripheral power feed lines L1 to L3, e.g., the outermost peripheral power feed line L1, and a zero voltage is applied to the outermost peripheral power feed lines L2 and L3. In this case, currents may flow in the two selected heater sections 100A and 100C adjacent to each other. In the state S24, it is possible to heat only the heater sections 100A and 100C.

The heater sections heated in the state S24 are the same as those in the state S23, but the directions of currents in two states S23 and S24 are opposite. Further, it is apparent that it is possible to obtain the same power supply pattern as that of the state S24 by applying a voltage to only one of the other outermost peripheral power feed lines L2 and L3 instead of the outermost peripheral power feed line L1.

In state S25, a case including the outermost peripheral power feed line set in a floating state (F) is illustrated as an example. A voltage is applied to one of the outermost peripheral power feed lines L1 to L3, e.g., the outermost peripheral power feed line L1, a zero voltage is applied to the outermost peripheral power feed line L3, and the outermost peripheral power feed line L2 is set in a floating state. In this case, currents may flow in all of the heater sections 100A to 100C, thereby heating the heater sections 100A to 100C.

In this case, the heater sections 100A and 100B are connected in series between the outermost peripheral power feed lines L1 and L3 involved in the current supply. The current flowing in the heater sections 100A and 100B are ½ of the current flowing in the heater section 100C (the electric power applied to each of the heater sections 100A and 100B is ¼ of the power applied to the heater section 100C). Further, it is apparent that it is possible to obtain the same current supply pattern as that of the state S25 by applying a voltage to any one of the three outermost peripheral power feed lines L1 to L3 and setting any other one of the outermost peripheral power feed lines in a floating state.

Further, the outermost peripheral resistance heater has been divided into three or four sections in the above-described embodiments. However, the number of the divided sections may be an even or odd number equal to or greater than three without being limited thereto.

Further, the mounting table body 62 is divided into two concentric heating zones of the inner peripheral zone and the outer peripheral zone in the above-described embodiments. However, the mounting table body 62 may be divided into three or more concentric heating zones, wherein the heating zone located at the outermost periphery is an outermost peripheral heating zone, and a resistance heater arranged in the outermost peripheral heating zone, i.e., an outermost peripheral resistance heater, is divided into a plurality of heater sections along its circumferential direction.

Further, the outermost peripheral power feed lines L1 to L4 extend to the central portion of the mounting table body 62 such that the resistance heater 98 of the inner peripheral zone is not interfered therewith in the above-described embodiments. However, if the resistance heater 98 of the inner peripheral zone and the outermost peripheral resistance heater 100 are arranged in two layers having different heights in a thickness direction, there is no need for the outermost peripheral power feed lines L1 to L4 to be arranged such that the resistance heater 98 of the inner peripheral zone is not interfered therewith. Thus, the freedom in design is increased.

Further, although the mounting table structure has the support column 64 in the above-described embodiments, the mounting table structure may be configured without having the support column 64. The material of the mounting table body 62 may be metal such as aluminum and an aluminum alloy without being limited to a ceramic material or quartz.

Further, although a voltage is applied by pulse control (digital control) in the above-described embodiments, analog control for varying an amplitude of the application voltage may be used instead of or in combination with the digital control.

Further, although one electrode serves as both of the electrostatic chuck and the lower electrode in the above-described embodiments, the electrode may be separately provided for each of the electrostatic chuck and the lower electrode. Further, the processing apparatus of the present invention is not limited to the parallel plate plasma processing apparatus as described above. That is, the present invention may be applied to a plasma process using high frequency waves or microwaves in an etching apparatus, a film forming apparatus and the like for forming different types of films.

Further, the present invention may be applied to a processing apparatus using no plasma, e.g., a thermal CVD film forming apparatus, a thermal oxidation apparatus, an annealing apparatus and a modification apparatus. In this case, a lower electrode is unnecessary. Further, although a target object is a semiconductor wafer in the above-described embodiments, the semiconductor wafer further includes a silicon substrate, or a compound semiconductor substrate such as GaAs, SiC and GaN substrates. Further, the target object may be a ceramic substrate or a glass substrate used in a liquid crystal display.

What is claimed is:

1. A mounting table structure for mounting a target object to perform a heat treatment on the target object in a processing chamber, the mounting table structure comprising:
a mounting table body on which the target object is mounted and which is divided into a plurality of concentric heating zones;
a plurality of resistance heaters provided in the mounting table body to correspond to the heating zones respectively;
a plurality of power feed lines which supply electric powers to the resistance heaters, the power feed lines connected to each of the resistance heaters of the heating zones being different from one another; and
a heater control unit provided to independently control the electric powers supplied to the resistance heaters for each of the heating zones;
wherein the resistance heaters include an outermost peripheral resistance heater that is arranged in an outermost peripheral heating zone of the heating zones, and the outermost peripheral resistance heater extends along a circumferential direction of the outermost peripheral heating zone,
the power feed lines include a plurality of outermost peripheral power feed lines to supply electric powers to the outermost peripheral resistance heater,
the outermost peripheral power feed lines are respectively connected to a plurality of different positions of the outermost peripheral resistance heater in the circumferential direction, so that the outermost peripheral resistance heater is divided into a plurality of heater sections by the positions, and
the heater control unit is configured to individually control electrical states of the respective outermost peripheral power feed lines.

2. The mounting table structure of claim 1, wherein the outermost peripheral resistance heater is a heater with no ends continuously extending along an entire circumference of the outermost peripheral heating zone.

3. The mounting table structure of claim 1, wherein the heater control unit has a plurality of different power supply states for the outermost peripheral resistance heater, each of the power supply states is a combination of the electrical states of the respective outermost peripheral power feed lines, and the heater control unit is configured to switch the power supply states by time division control.

4. The mounting table structure of claim 1, wherein the outermost peripheral resistance heater is divided into an even number of the heater sections.

5. The mounting table structure of claim 4, wherein the heater control unit has a power supply state to allow currents to flow in all of the heater sections of the outermost peripheral resistance heater.

6. The mounting table structure of claim 4, wherein the heater control unit has a power supply state to allow currents to flow in selected two of the heater sections opposite to each other.

7. The mounting table structure of claim 4, wherein the heater control unit has a power supply state to allow currents to flow in selected two of the heater sections adjacent to each other.

8. The mounting table structure of claim 1, wherein the outermost peripheral resistance heater is divided into an odd number of the heater sections.

9. The mounting table structure of claim 8, wherein the heater control unit has a power supply state to allow currents to flow in selected two of the heater sections adjacent to each other.

10. The mounting table structure of claim 3, wherein the heater control unit has a power supply state to set one or more of the outermost peripheral power feed lines in a floating state.

11. The mounting table structure of claim 1, wherein the outermost peripheral resistance heater is divided into three or more heater sections.

12. The mounting table structure of claim 1, wherein the mounting table body is formed of a ceramic material or quartz.

13. A processing apparatus for performing a heat treatment on a target object, the apparatus comprising: an evacuable processing chamber; the mounting table structure of claim 1 provided in the processing chamber to mount the target object; and a gas introduction unit which introduces a gas into the processing chamber.
